(19) United States
(12) Patent Application Publication
(10) Pub. No.: US 2025/0307630 A1
(43) Pub. Date: Oct. 2, 2025

(54) METHOD FOR TRAINING DEEP LEARNING MODEL FOR GENERATIVE RETRIEVAL AND APPARATUS FOR PERFORMING QUERY INFERENCE USING PRE-TRAINED DEEP LEARNING MODEL

(71) Applicant: RESEARCH & BUSINESS FOUNDATION SUNGKYUNKWAN UNIVERSITY, Suwon-si (KR)

(72) Inventors: Sunkyung LEE, Suwon-si (KR); Minjin CHOI, Suwon-si (KR); Jongwuk LEE, Suwon-si (KR)

(21) Appl. No.: 19/088,736

(22) Filed: Mar. 24, 2025

(30) Foreign Application Priority Data
Mar. 27, 2024 (KR) 10-2024-0041745

(51) Int. Cl. G06N 3/08

(52) U.S. Cl. CPC G06N 3/08

(57) ABSTRACT

In accordance with an embodiment of the present invention, there is provided a method for training a deep learning model for generative retrieval, the method comprising: performing a first training step of the deep learning model to generate vocabulary identifiers for each of at least two documents by receiving the at least two documents as input; and performing a second training step of the deep learning model to determine weights for the vocabulary identifiers by receiving a query, a relevant document associated with the query, and an irrelevant document not associated with the query as input.

### CROSS REFERENCE TO RELATED APPLICATION

The present application claims priority to Korean Patent Application No. 10-2024-0041745, filed on Mar. 27, 2024, the entire contents of which are hereby incorporated by this reference.

### TECHNICAL FIELD

The disclosure relates to a method of training a deep learning model for generative retrieval and an apparatus for performing query inference using a pre-trained deep learning model.

This work was supported by Institute of Information & communications Technology Planning & Evaluation (IITP) grant funded by the Korea government (Ministry of Science and ICT) (Project unique No.: 1711193374; Project No.: 2022-0-00680-00; R&D project: Development of core source technology for human-centered artificial intelligence; Research Project Title: An omni-data-driven abductive inference framework for understanding complex causal relationships; and Project period: 2024.01.01.˜2024.12.31.), Institute of Information & communications Technology Planning & Evaluation (IITP) grant funded by the Korea government (Ministry of Science and ICT) (Project unique No.: 2710007880; Project No.: II201821; R&D project: Digital Technology Leading Core Talent Development (R&D); Research Project Title: ICT Talent Development (Sungkyunkwan University); and Project period: 2024.01.01.˜2026.12.31.), and Institute of Information & communications Technology Planning & Evaluation (IITP) grant funded by the Korea government (Ministry of Science and ICT) (Project unique No.: 2710008628; Project No.: II190421; R&D project: Information and Communication Broadcasting Innovation Talent Training (R&D); Research Project Title: Artificial Intelligence Graduate School Support (Sungkyunkwan University); and Project period: 2024.01.01.˜2024.12.31.).

### BACKGROUND ART

In recent years, as deep learning technology has advanced dramatically, generative retrieval technology, which generates or extracts and provides appropriate information in response to a given query or request, has emerged and is primarily used in conversational systems or information retrieval systems.

However, in conventional generative retrieval technology, numeric identifiers generated through methods such as random number generation or hierarchical clustering have been used, but this approach presents a problem wherein a discrepancy arises between natural language generation and identifier generation due to a semantic inconsistency between natural language and the numeric identifiers.

In addition, since conventional generative retrieval models are trained solely to generate identifiers (or indexes), there exists a limitation in that the inference accuracy May degrade when multiple documents related to a given query exist.

Accordingly, there is a need to develop a technology capable of overcoming the discrepancy between natural language generation and identifier generation, as well as the discrepancy between the training and inference of a deep learning model, by training the deep learning model in a stepwise manner.

### DISCLOSURE

### Technical Problem

The problem to be solved by the disclosure is to improve vocabulary identifiers into a form optimized for document retrieval by performing a first training step of a deep learning model to generate vocabulary identifiers for documents and performing a second training step of the deep learning model to determine weights for the vocabulary identifiers indicating relevance between a query and documents.

In addition, the problem to be solved by the disclosure is to perform more accurate query inference based on the trained vocabulary identifiers and the weights for the vocabulary identifiers.

However, the problem to be solved by the present disclosure is not limited to that mentioned above, and other problems to be solved that are not mentioned may be clearly understood by those of ordinary skill in the art to which the present disclosure belongs from the following description.

### Technical Solution

In accordance with an embodiment of the present invention, there is provided a method for training a deep learning model for generative retrieval, the method comprising: performing a first training step of the deep learning model to generate vocabulary identifiers for each of at least two documents by receiving the at least two documents as input; and performing a second training step of the deep learning model to determine weights for the vocabulary identifiers by receiving a query, a relevant document associated with the query, and an irrelevant document not associated with the query as input. 2

Wherein the performing of the first training step of the deep learning model May include extracting at least two keywords for each of the at least two documents by considering word frequencies included in the at least two documents and training the deep learning model to generate top n (where n is a natural number) keywords among the at least two keywords as the vocabulary identifiers.

Wherein the performing of the first training step of the deep learning model May include extracting at least two keywords for the relevant document by considering word frequencies included in the relevant document by receiving the query as input and training the deep learning model to generate top n (where n is a natural number) keywords among the at least two keywords as vocabulary identifiers for the relevant document.

Wherein the performing of the first training step of the deep learning model May include performing transfer learning of the deep learning model using a pre-trained language model and training the deep learning model to minimize a first loss function determined based on the vocabulary identifiers generated through the transfer-learned deep learning model.

Wherein the performing of the second training step of the deep learning model May include determining a first embedding vector for the query, a second embedding vector for the relevant document, and a third embedding vector for the irrelevant document using the deep learning model and training the deep learning model to determine the weights for the vocabulary identifiers based on operations on the first, second, and third embedding vectors in an embedding space.

Wherein a similarity between the first embedding vector and the second embedding vector may be calculated to exceed a first threshold, and a similarity between the first embedding vector and the third embedding vector may be calculated to be less than a second threshold.

Wherein the irrelevant document may be a document having a vocabulary identifier with a prefix identical to a prefix of a vocabulary identifier for the relevant document.

Wherein the performing of the second training step of the deep learning model May include training the deep learning model to minimize a second loss function determined based on a first relevance score between the query and the relevant document and a second relevance score between the query and the irrelevant document.

Wherein the performing of the second training step of the deep learning model may include training the deep learning model to minimize a third loss function for mapping the query to the relevant document.

In accordance with another embodiment of the present invention, there is provided a method for performing query inference for generative retrieval using a pre-trained deep learning model to be performed by a query inference apparatus, the method comprising: generating vocabulary identifiers for each of the at least two documents by inputting the at least two documents into the pre-trained deep learning model; outputting a target vocabulary identifier and a weight for the target vocabulary identifier by inputting a target query into the pre-trained deep learning model; and retrieving a target document among the at least two documents by referring to the target vocabulary identifier and the weight for the target vocabulary identifier.

Wherein, when the at least two documents share the target vocabulary identifier, the retrieving of the target document may includes determining ranks for the at least two documents in consideration of the weight for the target vocabulary identifier and retrieving the target document based on the ranks of the at least two documents.

In accordance with another embodiment of the present invention, there is provided an apparatus for performing query inference for generative retrieval using a pre-trained deep learning model, the apparatus comprising: a memory storing a query inference program; and a processor configured to load the query inference program from the memory and execute the query inference program; wherein the query inference program, when executed by the processor, causes the processor to: generate vocabulary identifiers for each of the at least two documents by inputting the at least two documents into the pre-trained deep learning model; output a target vocabulary identifier and a weight for the target vocabulary identifier by inputting a target query into the pre-trained deep learning model; and retrieve a target document among the at least two documents by referring to the target vocabulary identifier and the weight for the target vocabulary identifier.

Wherein, when the at least two documents share the target vocabulary identifier, wherein the query inference program, when executed by the processor, may cause the processor to further determine ranks for the at least two documents in consideration of the weight for the target vocabulary identifier and retrieve the target document based on the ranks of the at least two documents.

In accordance with another embodiment of the present invention, there is provided a non-transitory computer-readable storage medium storing a computer program, wherein the computer program, when executed by a processor, includes instructions for causing the processor to perform a method, the method comprising: performing a first training step of the deep learning model to generate vocabulary identifiers for each of at least two documents by receiving the at least two documents as input; and performing a second training step of the deep learning model to determine weights for the vocabulary identifiers by receiving a query, a relevant document associated with the query, and an irrelevant document not associated with the query as input.

In accordance with another embodiment of the present invention, there is provided a computer program stored in a non-transitory computer-readable storage medium, wherein the computer program, when executed by a processor, includes instructions for causing the processor to perform a method, the method comprising: performing a first training step of the deep learning model to generate vocabulary identifiers for each of at least two documents by receiving the at least two documents as input; and performing a second training step of the deep learning model to determine weights for the vocabulary identifiers by receiving a query, a relevant document associated with the query, and an irrelevant document not associated with the query as input.

In accordance with another embodiment of the present invention, there is provided a non-transitory computer-readable storage medium storing a computer program, wherein the computer program, when executed by a processor, includes instructions for causing the processor to perform a method, the method comprising: generating vocabulary identifiers for each of the at least two documents by inputting the at least two documents into the pre-trained deep learning model; outputting a target vocabulary identifier and a weight for the target vocabulary identifier by inputting a target query into the pre-trained deep learning model; and retrieving a target document among the at least two documents by referring to the target vocabulary identifier and the weight for the target vocabulary identifier.

In accordance with another embodiment of the present invention, there is provided a computer program stored in a non-transitory computer-readable storage medium, wherein the computer program, when executed by a processor, includes instructions for causing the processor to perform a method, the method comprising: generating vocabulary identifiers for each of the at least two documents by inputting the at least two documents into the pre-trained deep learning model; outputting a target vocabulary identifier and a weight for the target vocabulary identifier by inputting a target query into the pre-trained deep learning model; and retrieving a target document among the at least two documents by referring to the target vocabulary identifier and the weight for the target vocabulary identifier.

### Advantageous Effects

According to an embodiment of the disclosure, through a first training step and a second training step of the deep learning model, the deep learning model may not only learn a ranking relationship according to a query for relevant or irrelevant documents, but also learn a relationship between the query and the relevant documents.

In addition, according to an embodiment of the disclosure, by using the pre-trained deep learning model so as to generate vocabulary identifiers and determine the weights for the vocabulary identifiers, document retrieval corresponding to a query may be performed more accurately from a large document corpus.

### BRIEF DESCRIPTION OF THE DRAWINGS

FIG. 1 is a block diagram illustrating a query inference apparatus according to an embodiment of the disclosure.

FIG. 2 is a block diagram conceptually illustrating functions of the query inference program according to an embodiment of the disclosure.

FIG. 3 is a flowchart illustrating a method of training a deep learning model according to an embodiment of the disclosure.

FIG. 4 is a diagram exemplarily illustrating a method of training a deep learning model in a stepwise manner according to an embodiment of the disclosure.

FIG. 5 is a flowchart illustrating a method of performing query inference using the pre-trained deep learning model according to an embodiment of the disclosure.

FIG. 6 is a diagram exemplarily illustrating a method of retrieving a document corresponding to a given query using the pre-trained deep learning model according to an embodiment of the disclosure.

### DETAILED DESCRIPTION OF THE INVENTION

The advantages and features of the embodiments and the methods of accomplishing the embodiments will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

In describing the embodiments of the present invention, detailed descriptions of well-known functions or configurations may be omitted when it is determined that such descriptions could unnecessarily obscure the gist of the present invention. Furthermore, the terms used below are defined in consideration of the functions of the embodiments of the present invention, and may vary depending on the intentions or practices of users or operators.

Therefore, the definitions should be made based on the overall content of this specification.

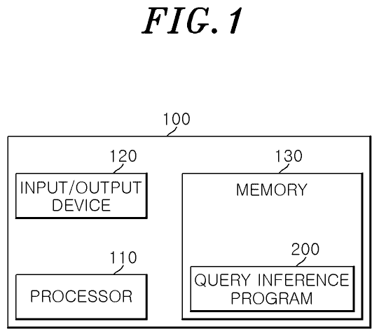

FIG. 1 is a block diagram illustrating a query inference apparatus according to an embodiment of the disclosure.

With reference to FIG. 1, a query inference apparatus 100 may include a processor 110, an input/output device 120, and a memory 130.

The processor 110 may generally control operations of the query inference apparatus 100.

The processor 110 may receive at least two documents as input using the input/output device 120. In addition, the processor 110 may further receive a query, a relevant document associated with the query, and an irrelevant document not associated with the query as input, using the input/output device 120.

Here, the at least two documents, the relevant document, and the irrelevant document, according to an embodiment of the disclosure, may refer to documents included in an offline or online document database (e.g., a large document corpus).

In the disclosure, although the at least two documents, the query, the relevant document, and the irrelevant document are described as being input through the input/output device 120, the disclosure is not limited thereto. That is, according to an embodiment, the query inference apparatus 100 may include a transceiver (not illustrated), and the query inference apparatus 100 may receive at least one of the at least two documents, the query, the relevant document, or the irrelevant document, using the transceiver (not illustrated). At least one of the at least two documents, the query, the relevant document, or the irrelevant document may also be generated within the query inference apparatus 100.

The processor 110 may perform a first training step of a deep learning model to generate vocabulary identifiers for each of at least two documents by receiving the at least two documents as input.

Additionally, the processor 110 may perform a second training step of the deep learning model to determine weights for the vocabulary identifiers by receiving the query, the relevant document associated with the query, and the irrelevant document not associated with the query as input.

In addition, the processor 110 may input the at least two documents into the pre-trained deep learning model to generate vocabulary identifiers for each of the at least two documents.

Further, the processor 110 may input a target query into the pre-trained deep learning model and may retrieve a target document among the at least two documents by referring to a target vocabulary identifier and a weight for the target vocabulary identifier output therefrom.

The input/output device 120 may include one or more input devices and/or one or more output devices. For example, the input devices may include a microphone, a keyboard, a mouse, or a touchscreen, etc., and the output devices may include a display or a speaker, etc.

The memory 130 may store a query inference program 200 and information necessary for executing the query inference program 200.

In this specification, the query inference program 200 may refer to software including instructions for performing a first training step of a deep learning model to generate vocabulary identifiers for each of at least two documents by receiving the at least two documents as input, and for performing a second training step of the deep learning model to determine weights for the vocabulary identifiers by receiving the query, the relevant document associated with the query, and the irrelevant document not associated with the query as input.

In addition, in this specification, the query inference program 200 may refer to software including instructions for inputting the at least two documents and the target query into the pre-trained deep learning model and retrieving a target document among the at least two documents by referring to a target vocabulary identifier and a weight for the target vocabulary identifier output therefrom.

The processor 110 may load the query inference program 200 and the information necessary for executing the query inference program 200 from the memory 130 in order to execute the query inference program 200.

The processor 110 may execute the query inference program 200 to input at least two documents and a target query into the pre-trained deep learning model, and may retrieve a target document among the at least two documents by referring to a target vocabulary identifier and a weight for the target vocabulary identifier output therefrom.

In the disclosure, the deep learning model may include an indexing model and a retrieval model. For example, the indexing model may refer to a model that receives a document as input and outputs a vocabulary identifier, and the retrieval model may refer to a model that receives a query as input and outputs a vocabulary identifier.

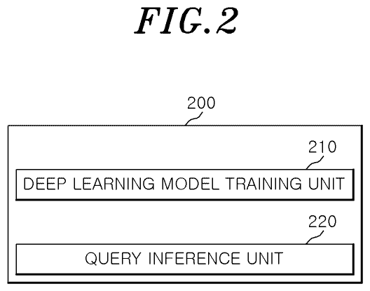

The functions and/or operations of the query inference program 200 will now be described in more detail with reference to FIG. 2.

FIG. 2 is a block diagram conceptually illustrating functions of the query inference program according to an embodiment of the disclosure.

With reference to FIG. 2, the query inference program 200 may include a deep learning model training unit 210 and a query inference unit 220.

The deep learning model training unit 210 and the query inference unit 220 illustrated in FIG. 2 are conceptual divisions of the functions of the query inference program 200 for ease of explanation of the functions of the query inference program 200 and are not limited thereto. Depending on the embodiments, the functions of the deep learning model training unit 210 and the query inference unit 220 may be merged or separated (i.e., training and inference of the deep learning model may be performed independently), and may also be implemented as a series of instructions included in a single program.

First, the deep learning model training unit 210 may perform a first training step of the deep learning model to generate vocabulary identifiers for each of at least two documents by receiving the at least two documents as input.

For example, the deep learning model training unit 210 may input the at least two documents into the indexing model to extract at least two keywords for each of the at least two documents.

Specifically, the deep learning model training unit 210 may extract at least two keywords for each of the at least two documents by considering word frequencies included in the at least two documents.

More specifically, the deep learning model training unit 210 may use a keyword extractor to determine importance scores (e.g., tf-idf scores) of words included in each of the at least two documents based on calculations that consider a frequency at which a first specific word appears in a specific document and the number of documents in which the first specific word appears, thereby extracting at least two keywords for each of the at least two documents.

In another example, the deep learning model training unit 210 may input a query into the retrieval model to extract at least two keywords for a relevant document.

Specifically, the deep learning model training unit 210 may receive a query as input to extract at least two keywords for the relevant document by considering frequencies of words included in the relevant document.

More specifically, the deep learning model training unit 210 may use the keyword extractor to determine importance scores (e.g., tf-idf scores) of words included in the relevant document based on calculations that consider a frequency at which a second specific word appears in the relevant document and the number of documents in which the second specific word appears, thereby extracting at least two keywords for the relevant document.

In addition, the deep learning model training unit 210 may train the deep learning model to generate top n keywords (where n is a natural number) among the at least two keywords as vocabulary identifiers.

More specifically, the deep learning model training unit 210 may determine the top n keywords based on importance scores (e.g., tf-idf scores) of words included in each of the at least two documents and words included in the relevant document, and may train the deep learning model to generate the top n keywords as vocabulary identifiers. Here, the top n keywords may refer to the top n keywords with the highest importance scores when listing the words included in each of at least two documents and words included in the relevant document, based on the aforementioned importance scores. Here, n may be a value preset by a user.

Meanwhile, the deep learning model training unit 210 may perform transfer learning using a pre-trained language model.

For example, the deep learning model training unit 210 may initialize parameters of the deep learning model using a pre-trained language model (e.g., T5), and the pre-trained language model (e.g., T5) and the deep learning model may share parameters.

In addition, the deep learning model training unit 210 may train the deep learning model to minimize a first loss function determined based on vocabulary identifiers generated through the transfer-learned deep learning model.

For example, the deep learning model training unit 210 may train the deep learning model to minimize the first loss function representing a loss between tokens of the vocabulary identifiers generated through the transfer-learned deep learning model using the pre-trained language model (e.g., T5) and the extracted keyword tokens.

Through this, a distinctive effect of alleviating a discrepancy between natural language generation and vocabulary identifier generation may be achieved.

Next, the deep learning model training unit 210 may perform a second training step of the deep learning model to determine weights for the vocabulary identifiers by receiving a query, a relevant document associated with the query, and an irrelevant document not associated with the query as input.

Here, the weight for the vocabulary identifier according to an embodiment of the disclosure may refer to a weight representing a correlation between the query and the relevant document. In addition, the irrelevant document according to an embodiment of the disclosure may refer to a document having a vocabulary identifier with a prefix identical to that of the vocabulary identifier for the relevant document. For example, the irrelevant document may be extracted from a document corpus based on prefix-aware dynamic negative sampling.

Specifically, the deep learning model training unit 210 may determine a first embedding vector for the query, a second embedding vector for the relevant document, and a third embedding vector for the irrelevant document using the deep learning model.

For example, the deep learning model training unit 210 may input a triplet of the query, the relevant document, and the irrelevant document into the deep learning model to determine a first embedding vector corresponding to the query representation, a second embedding vector corresponding to the relevant document representation, and a third embedding vector corresponding to the irrelevant document representation.

In addition, the deep learning model training unit 210 may train the deep learning model to determine the weights for the vocabulary identifiers based on operations on the first embedding vector, the second embedding vector, and the third embedding vector in the embedding space.

For example, a similarity between the first embedding vector and the second embedding vector may be calculated to exceed a first threshold, and a similarity between the first embedding vector and the third embedding vector may be calculated to be less than a second threshold.

That is, the deep learning model training unit 210 may train the deep learning model to bring the query representation closer to the relevant document representation and farther from the irrelevant document representation in the representation space, such that the weight for the vocabulary identifier representing the correlation between the query and the relevant document is appropriately learned.

More specifically, the deep learning model training unit 210 may train the deep learning model to minimize a second loss function determined based on a first relevance score between the query and the relevant document and a second relevance score between the query and the irrelevant document.

Here, the first relevance score may be determined through an operation on the query representation and the relevant document representation determined by the deep learning model, and the second relevance score may be determined through an operation on the query representation and the irrelevant document representation determined by the deep learning model.

In addition, the deep learning model training unit 210 may train the deep learning model to minimize a third loss function for mapping the query to the relevant document.

The deep learning model training unit 210 may also train the deep learning model to minimize a fourth loss function determined based on a weighted sum of the second loss function and the third loss function.

As such, as the deep learning model training unit 210 trains the deep learning model to minimize the second loss function and the third loss function, the deep learning model May not only learn a ranking relationship according to a query for a relevant or irrelevant document, but also learn a relationship between the query and the relevant document, thereby achieving a distinctive effect. 16 Meanwhile, the query inference unit 220 may input at least two documents into the pre-trained deep learning model to generate vocabulary identifiers for each of the at least two documents.

For example, the query inference unit 220 may input at least two documents into the pre-trained indexing model in an offline state to generate vocabulary identifiers for each of the at least two documents.

Additionally, the query inference unit 220 may input a target query into the pre-trained deep learning model to output a target vocabulary identifier and a weight for the target vocabulary identifier.

For example, in an online state, the query inference unit 220 may input the target query into the pre-trained retrieval model to output the target vocabulary identifier and a weight corresponding to the target vocabulary identifier.

In addition, the query inference unit 220 may retrieve a target document among the at least two documents by referring to the target vocabulary identifier and the weight for the target vocabulary identifier.

For example, when the at least two documents share the target vocabulary identifier, the query inference unit 220 may determine ranks for the at least two documents in consideration of the weight for the target vocabulary identifier, and may retrieve the target document corresponding to the query based on the ranks of the at least two documents.

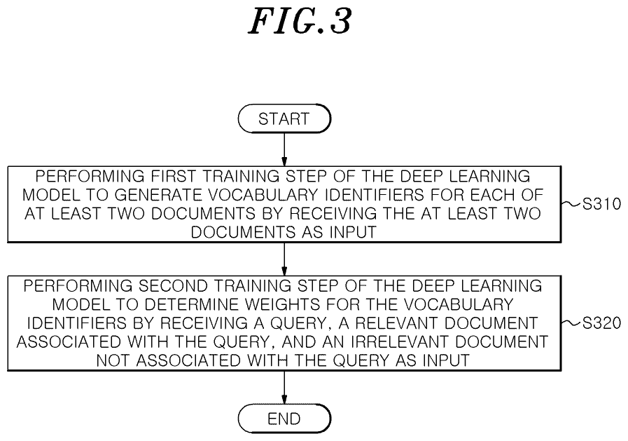

FIG. 3 is a flowchart illustrating a method of training a deep learning model according to an embodiment of the disclosure.

With reference to FIGS. 2 and 3, the deep learning model training unit 210 May perform a first training step of the deep learning model to generate vocabulary identifiers for each of at least two documents by receiving the at least two documents as input (S310).

Subsequently, the deep learning model training unit 210 may perform a second training step of the deep learning model to determine weights for the vocabulary identifiers by receiving a query, a relevant document associated with the query, and an irrelevant document not associated with the query as input (S320).

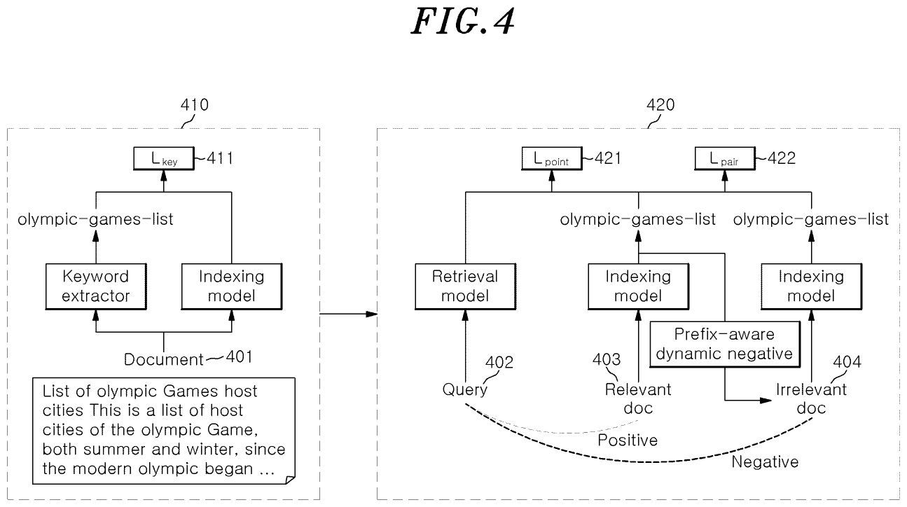

FIG. 4 is a diagram exemplarily illustrating a method of training a deep learning model in a stepwise manner according to an embodiment of the disclosure.

With reference to FIGS. 2 and 4, a process 410 of performing a first training step of the deep learning model and a process 420 of performing a second training step of the deep learning model are illustrated.

First, in the process 410 of performing the first training step of the deep learning model, the deep learning model training unit 210 may train the deep learning model to generate vocabulary identifiers by receiving at least two documents as input.

Specifically, the deep learning model training unit 210 may extract at least two keywords (i.e., “Olympic,” “games,” and “list”) by considering word frequencies included in the document 401 using a keyword extractor.

In addition, the deep learning model training unit 210 may update parameters of the deep learning model through backpropagation to minimize a first loss function 411 representing a loss between the extracted at least two keyword tokens and vocabulary identifier tokens generated through the transfer-learned indexing model using the pre-trained language model, and the first loss function 411 may be expressed as in Equation 1 below.

$${L}_{key} = - {\sum }_{t = 1}^{n} log P ( {z}_{t}^{key} \vert d , {D}_{< t} ) \qquad Equation 1$$

Here, L_{key} may refer to the first loss function,

$${z}_{t}^{key}$$

may refer to the tokens of the vocabulary identifiers extracted using the keyword extractor, d may refer to a document, and D_{<t} may refer to the tokens of the vocabulary identifiers generated using the deep learning model.

Next, in the process 420 of performing a second training step of the deep learning model, the deep learning model training unit 210 may receive a query 402, a relevant document 403 associated with the query, and an irrelevant document 404 not associated with the query as input, and may perform a second training step of the deep learning model to determine weights for vocabulary identifiers. Here, the irrelevant document 404 may be extracted from a document corpus based on prefix-aware dynamic negative sampling.

Specifically, the deep learning model training unit 210 may train the deep learning model such that, in the representation space, the query representation is brought closer to the relevant document representation (e.g., embedding vectors for “olympic,” “games,” and “list”) and farther from the irrelevant document representation (e.g., embedding vectors for “olympic,” “games,” and “win”).

More specifically, the deep learning model training unit 210 may update parameters of the deep learning model through backpropagation to minimize a second loss function 422, which is determined based on a first relevance score between the query 402 and the relevant document 403 and a second relevance score between the query 402 and the irrelevant document 404. The second loss function 422 may be expressed as in Equation 2 below.

$${L}_{pair} = - log \frac{exp ( rel ( q , {d}^{+} ) )}{exp ( rel ( q , {d}^{+} ) ) + {\sum }_{{d}^{-} ϵ N} exp ( rel ( q , {d}^{-} ) )} \qquad Equation 2$$

Here, Lₚₐᵢᵣ may refer to the second loss function, rel(q, d⁺) may refer to the first relevance score, (rel(q, d⁻) may refer to the second relevance score, q may refer to the query, d⁺ may refer to the relevant document, and d⁻ may refer to the irrelevant document.

In addition, the deep learning model training unit 210 may train the deep learning model to minimize a third loss function 421 for mapping the query 402 to the relevant document 403, and the third loss function 421 may be expressed as in Equation 3 below.

$${L}_{point} = - {\sum }_{t = 1}^{n} log P ( {z}_{t}^{+} \vert q , {q}_{< t} ) + {λ}_{dist} \cdot dist ( {ω}^{q} , {ω}^{{d}^{+}} ) \qquad Equation 3$$

$${L}_{point} = - {\sum }_{t = 1}^{n} log P ( {z}_{t}^{+} \vert q , {q}_{< t} ) + {λ}_{dist} \cdot dist ( {ω}^{q} , {ω}^{{d}^{+}} )$$

Here, Lₚₒᵢₙₜ may refer to the third loss function,

$${z}_{t}^{+}$$

may refer to the representation of the vocabulary identifier for the relevant document, ω^{q} may refer to the logit of the vocabulary identifier for the query,

$${ω}^{{d}^{+}}$$

may refer to the logit of the vocabulary identifier for the relevant document, and dist(⋅) may refer to cosine similarity.

As such, as the deep learning model training unit 210 trains the deep learning model to minimize the second loss function 422 and the third loss function 421, the deep learning model may not only learn a ranking relationship according to the query 402 for the relevant document 403 or the irrelevant document 404, but also learn a relationship between the query 402 and the relevant document 403, thereby achieving a distinctive effect.

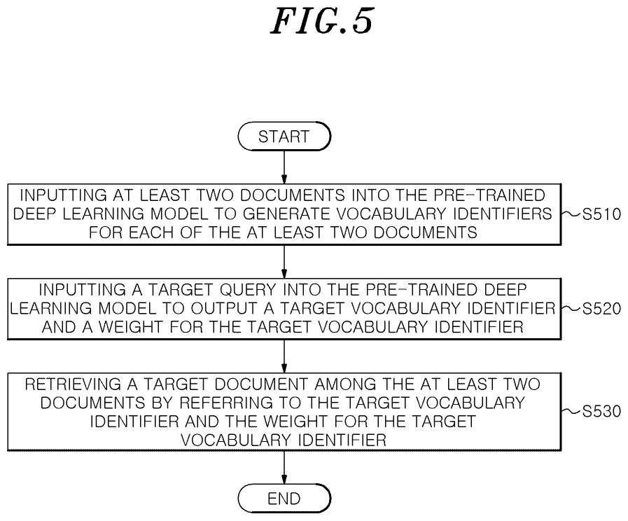

FIG. 5 is a flowchart illustrating a method of performing query inference using the pre-trained deep learning model according to an embodiment of the disclosure.

With reference to FIGS. 2 and 5, the query inference unit 220 may input at least two documents into the pre-trained deep learning model to generate vocabulary identifiers for each of the at least two documents (S510).

Next, the query inference unit 220 may input a target query into the pre-trained deep learning model to output a target vocabulary identifier and a weight for the target vocabulary identifier (S520).

Then, the query inference unit 220 may retrieve a target document among the at least two documents by referring to the target vocabulary identifier and the weight for the target vocabulary identifier (S530).

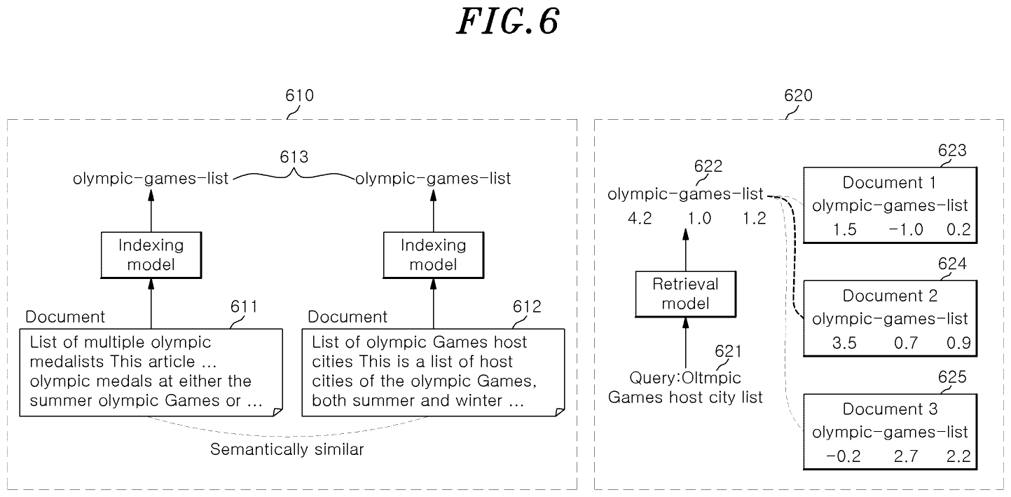

FIG. 6 is a diagram exemplarily illustrating a method of retrieving a document corresponding to a given query using the pre-trained deep learning model according to an embodiment of the disclosure.

With reference to FIGS. 2 and 6, a query inference process 610 in an offline state using the pre-trained deep learning model and a query inference process 620 in an online state using the deep learning model are illustrated. 2 First, with reference to the query inference process 610 in the offline state, the query inference unit 220 may input all documents included in a document corpus into the pre-trained indexing model to generate vocabulary identifiers for each of all the documents.

Specifically, through the query inference process 610 in the offline state, a first document 611 and a second document 612, which are semantically similar, may share a target vocabulary identifier 613 (i.e., “olympic-games-list”).

Next, with reference to the query inference process 620 in the online state, the query inference unit 220 may input a target query (i.e., “Olympic games host city list”) into the pre-trained retrieval model to output a target vocabulary identifier and a weight 622 of the target vocabulary identifier. In this case, it may be confirmed that “olympic” has the highest weight among the weights 622 of the target vocabulary identifier.

In addition, the query inference unit 220 may determine ranks of at least two documents in consideration of the weights 622 of the target vocabulary identifier and may retrieve a target document based on the ranks of the at least two documents. 16

Specifically, through the query inference process 620 in the online state, the query inference unit 220 may retrieve a fourth document 624, which has the highest weight for “olympic”, as the target document among a third document 623, the fourth document 624, and a fifth document 625.

Meanwhile, the method of retrieving the target document based on the highest weight is merely one example, and the method of retrieving the target document may be variously modified within the scope achievable by the disclosure.

As such, by using the pre-trained deep learning model to generate vocabulary identifiers and determine weights for the vocabulary identifiers, query inference may be performed more accurately from a large document corpus.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer-readable storage medium which can be directed to a computer or other programmable data processing equipment to implement a function in a specific manner. Accordingly, the instructions stored on the computer-usable or computer-readable recording medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

In addition, each step may represent a module, a segment, or a portion of codes which contains one or more executable instructions for executing the specified logical function(s). It should also be noted that in some alternative embodiments, the functions mentioned in the steps may occur out of order. For example, two steps illustrated in succession may in fact be performed substantially simultaneously, or the steps May sometimes be performed in a reverse order depending on the corresponding function.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

1. A method for training a deep learning model for generative retrieval to be performed by a query inference apparatus, the method comprising:
performing a first training step of the deep learning model to generate vocabulary identifiers for each of at least two documents by receiving the at least two documents as input; and
performing a second training step of the deep learning model to determine weights for the vocabulary identifiers by receiving a query, a relevant document associated with the query, and an irrelevant document not associated with the query as input.

2. The method of claim 1, wherein the performing of the first training step of the deep learning model includes:
extracting at least two keywords for each of the at least two documents by considering word frequencies included in the at least two documents; and
training the deep learning model to generate top n (where n is a natural number) keywords among the at least two keywords as the vocabulary identifiers.

3. The method of claim 1, wherein the performing of the first training step of the deep learning model includes:
extracting at least two keywords for the relevant document by considering word frequencies included in the relevant document by receiving the query as input; and
training the deep learning model to generate top n (where n is a natural number) keywords among the at least two keywords as vocabulary identifiers for the relevant document.

4. The method of claim 1, wherein the performing of the first training step of the deep learning model includes:
performing transfer learning of the deep learning model using a pre-trained language model; and
training the deep learning model to minimize a first loss function determined based on the vocabulary identifiers generated through the transfer-learned deep learning model.

5. The method of claim 1, wherein the performing of the second training step of the deep learning model includes:
determining a first embedding vector for the query, a second embedding vector for the relevant document, and a third embedding vector for the irrelevant document using the deep learning model; and
training the deep learning model to determine the weights for the vocabulary identifiers based on operations on the first, second, and third embedding vectors in an embedding space.

6. The method of claim 5, wherein a similarity between the first embedding vector and the second embedding vector is calculated to exceed a first threshold, and a similarity between the first embedding vector and the third embedding vector is calculated to be less than a second threshold.

7. The method of claim 1, wherein the irrelevant document is a document having a vocabulary identifier with a prefix identical to a prefix of a vocabulary identifier for the relevant document.

8. The method of claim 1, wherein the performing of the second training step of the deep learning model includes:
training the deep learning model to minimize a second loss function determined based on a first relevance score between the query and the relevant document and a second relevance score between the query and the irrelevant document.

9. The method of claim 1, wherein the performing of the second training step of the deep learning model includes:
training the deep learning model to minimize a third loss function for mapping the query to the relevant document.

10. A method for performing query inference for generative retrieval using a pre-trained deep learning model to be performed by a query inference apparatus, the method comprising:
generating vocabulary identifiers for each of the at least two documents by inputting the at least two documents into the pre-trained deep learning model;
outputting a target vocabulary identifier and a weight for the target vocabulary identifier by inputting a target query into the pre-trained deep learning model; and
retrieving a target document among the at least two documents by referring to the target vocabulary identifier and the weight for the target vocabulary identifier.

11. The method of claim 10, wherein, when the at least two documents share the target vocabulary identifier, the retrieving of the target document includes:
determining ranks for the at least two documents in consideration of the weight for the target vocabulary identifier; and
retrieving the target document based on the ranks of the at least two documents.

12. An apparatus for performing query inference for generative retrieval using a pre-trained deep learning model, the apparatus comprising:
a memory storing a query inference program; and
a processor configured to load the query inference program from the memory and execute the query inference program;
wherein the query inference program, when executed by the processor, causes the processor to:
generate vocabulary identifiers for each of the at least two documents by inputting the at least two documents into the pre-trained deep learning model;
output a target vocabulary identifier and a weight for the target vocabulary identifier by inputting a target query into the pre-trained deep learning model; and
retrieve a target document among the at least two documents by referring to the target vocabulary identifier and the weight for the target vocabulary identifier.

13. The apparatus of claim 12, wherein, when the at least two documents share the target vocabulary identifier, wherein the query inference program, when executed by the processor, causes the processor further to:
determine ranks for the at least two documents in consideration of the weight for the target vocabulary identifier; and
retrieve the target document based on the ranks of the at least two documents.
